(19) United States
(12) Patent Application Publication
(10) Pub. No.: US 2011/0099153 A1
(43) Pub. Date: Apr. 28, 2011

(54) METHOD AND APPARATUS FOR GENERATING A POLYMORPHIC NOTE

(75) Inventors: Keith Barraclough, Mountain View, CA (US); Stephen Hartford, San Jose, CA (US); David Irvine, San Jose, CA (US); Erich Domingo, Hayward, CA (US); Christopher Dame, San Francisco, CA (US); Christopher Nyffeler, San Francisco, CA (US); Anke Pierik, El Granada, CA (US); Kristian Simsarian, San Francisco, CA (US); James Gerlach, Santa Clara, CA (US)

(73) Assignee: Nokia Corporation, Espoo (FI)

(21) Appl. No.: 12/605,934

(22) Filed: Oct. 26, 2009

(51) Int. Cl. G06F 17/30

(52) U.S. Cl. 707/691; 707/736; 707/783; 707/E17.005; 707/E17.044

(57) ABSTRACT

An approach is provided for generating a polymorphic note. A polymorphic note manager receives a request, from a device, to generate a polymorphic note, wherein the polymorphic note includes information of a plurality of application types that is developed over a period of time. The polymorphic note manager then generates the polymorphic note in response to the request and stores the polymorphic note for access by the device.

### BACKGROUND

Service providers and device manufacturers are continually challenged to deliver value and convenience to consumers by, for example, providing compelling network services and advancing the underlying technologies. One area of interest has been the development of services and technologies for personal information management (e.g., calendaring, task management, goal planning, and the like). In particular, service providers and device manufacturers face significant technical challenges in adapting such personal information management services for organizing and planning the personal and social lives of users where events, goals, and plans are fluid, dynamic, and nebulous.

### SOME EXAMPLE EMBODIMENTS

Therefore, there is a need for an approach for intuitively organizing information (e.g., personal and social information) using a polymorphic note capable of evolving as the information develops.

According to one embodiment, a method comprises receiving a request, from a device, to generate a polymorphic note. The polymorphic note includes information of a plurality of application types that is developed over a period of time. The method also comprises generating the polymorphic note in response to the request. The method further comprises storing the polymorphic note for access by the device.

According to another embodiment, an apparatus comprising at least one processor, and at least one memory including computer program code, the at least one memory and the computer program code configured to, with the at least one processor, cause, at least in part, the apparatus to receive a request, from a device, to generate a polymorphic note. The polymorphic note includes information of a plurality of application types that is developed over a period of time. The apparatus is also caused to generate the polymorphic note in response to the request. The apparatus is further caused to store the polymorphic note for access by the device.

According to another embodiment, a computer-readable storage medium carrying one or more sequences of one or more instructions which, when executed by one or more processors, cause, at least in part, an apparatus to receive a request, from a device, to generate a polymorphic note. The polymorphic note includes information of a plurality of application types that is developed over a period of time. The apparatus is also caused to generate the polymorphic note in response to the request. The apparatus is further caused to store the polymorphic note for access by the device.

According to another embodiment, an apparatus comprises means for receiving a request, from a device, to generate a polymorphic note. The polymorphic note includes information of a plurality of application types that is developed over a period of time. The apparatus also comprises means for generating the polymorphic note in response to the request. The apparatus further comprises means for storing the polymorphic note for access by the device.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating a polymorphic note, according to one embodiment;

FIG. 2 is a diagram of components of a polymorphic note manager, according to one embodiment;

FIG. 3 is a diagram of components of a polymorphic note, according to one embodiment;

FIG. 4 is a diagram illustrating organization of a plurality of polymorphic notes into electronic notebooks, according to one embodiment;

FIGS. 5A and 5B are flowcharts of a processes for generating a polymorphic note, according to various embodiments;

FIG. 6 is a flowchart of a process for storing and sharing a polymorphic note in an electronic notebook, according to one embodiment;

FIG. 7 is flowchart of a process for recording updates to the polymorphic note, according to one embodiment;

FIG. 8 is a diagram of a user interface for interacting with a polymorphic note, according to one embodiment;

FIGS. 9A and 9B are diagrams of user interfaces for entering information into a polymorphic note, according to various exemplary embodiments;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., a handset) that can be used to implement an embodiment of the invention.

### DESCRIPTION OF SOME EMBODIMENTS

Examples of a method, apparatus, and computer program for generating a polymorphic note. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

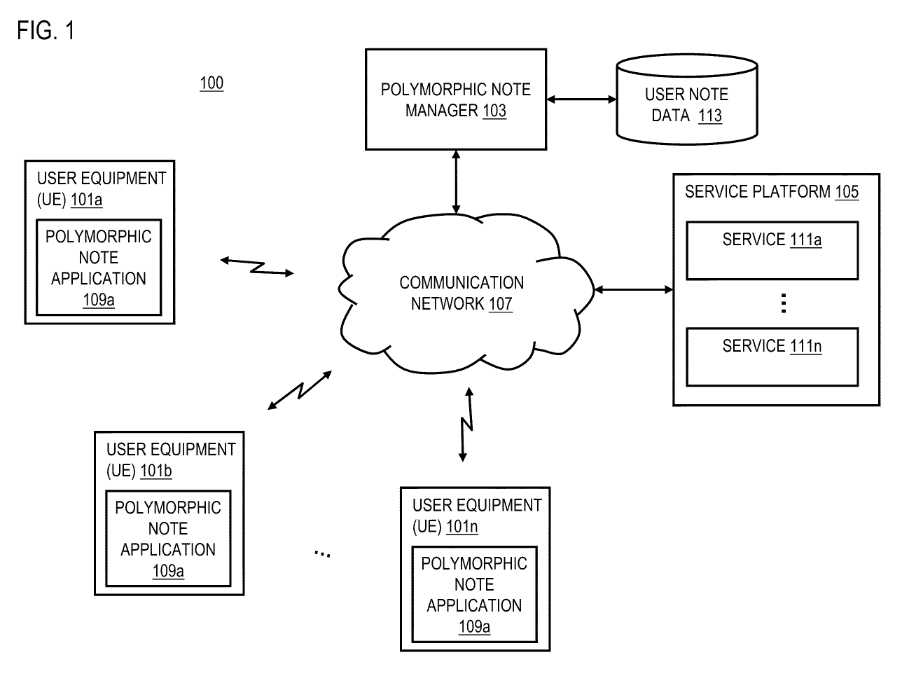

FIG. 1 is a diagram of a system capable of interacting with a content object, according to one embodiment. It is noted that there are numerous traditional electronic personal information management (PIM) solutions (e.g., calendaring applications, task management applications, etc.) for organizing a user's life available on the market. However, outside of business uses, there has been relatively little adoption or use of these traditional PIM solutions compared to e-mail, instant messaging, and other similar tools. This lack of adoption can be attributed, at least in part, on the fact that personal organizing often begins with potential events, fuzzy timeframes, and long-term goals. As users interact, these events, timeframes, and goals evolve into a more concrete form. Even then, this form can keep changing up to, during, and even after the event. Once an event has occurred, the planning documentation itself acts as a record of the vent that provokes memories and inspires future actions and events.

Moreover, users generally have their own complex organizational methods that are very personal and intuitive. These methods typically have not been supported by traditional PIM solutions, which require discrete up-front knowledge of what and when with regards to an event or goal before considering who or where. Under traditional approaches, little or no support exists for incorporating possible alternatives to events or ambitions that are not tied to a specific time (e.g., a general ambition to “get more exercise” with no specific accompanying details). In other words, a user has to know exactly what the user wants to do and when the user wants to do it before the user can even start creating or recording an event in a traditional PIM application or solution. The regimented and inflexible approach of traditional PIM solutions does not reflect how most people actually plan events or goals that build on an initial (often fragmented) idea. If a user wants to initiate an event with just a thought, the user is generally limited to recording the thought in a memo or task that is stranded in its own tool or application. When the thought becomes more concrete, there is typically no easy or automated way to transfer the information recorded in the memo or task to, for instance, a calendaring application. Because these PIM solutions do not meet the full spectrum of user needs, adoption of existing tools is limited primarily to specific segments of users' lives (e.g., most often as a tool used only for work).

To address these problems, the system 100 of FIG. 1 introduces the capability to generate a polymorphic note to enable a user or other authorized entity (e.g., a service provider, network operator, etc.) to record events, tasks, and other information whose details range from being concrete to ambiguous. It is noted that although several embodiments of the invention are discussed with respect to a user initiating or requesting the creation of a polymorphic note, it is recognized by one of ordinary skill in the art that the embodiments of the inventions have applicability to any entity (e.g., both users and non-users of the note) for initiating the creation of the note. For example, a service provider, network operator, content provider, and the like may create a note for users. In particular, a service provider may, for instance, create polymorphic notes as a way of communicating to all or some groups of users (e.g., communicating service updates, new functionalities, marketing information, etc.). Also, a service, service provider, or other authorized entity may create notes on behalf of the user, for instance, based on the user's usage behavior other pattern.

In the approach described herein, the polymorphic note of the system 100 supports the capability of recording the fluid evolution of idea or concept into an event, task, or other similar PIM element or information, thereby enabling users to record their ideas and plan events in a more natural and evolutionary way. More specifically, a polymorphic note is a common object model for information that relieves users of the need to decide if they are creating a meeting, an event, a task, or a simple memo. The polymorphic note supports a variety of information traditionally corresponding to separate and distinct application types (e.g., a calendar application, a task management application, a note application, an e-mail application, an instant messaging application, a text messaging application, a social networking application, a location application, or a combination thereof). From the perspective of the user, a polymorphic note can be thought of as an event, a task, a simple reminder, etc. that is able to evolve into other PIM objects or even combination of objects based on how the information within the polymorphic note develops. The note may then trigger any of a variety of predetermined actions based on the information stored in the notes. For example, based on contextual information in the polymorphic note (e.g., time, people, place, etc.), a service associated with the polymorphic note can perform an action or function (e.g., set reminders based on time, initiate communication sessions with people, show places on a map, etc.).

By providing a single object (i.e., the polymorphic note) that can fulfill the purposes or historically separate objects, the system 100 advantageously enables a more natural progression from a simple idea (e.g., a textual note) to a list of things to do next (e.g., a task) to a scheduled happening (e.g., a meeting, a social event, etc.) alone or with one or more friends. By way of example, planning an event is dynamic in which various options are considered from multiple sources and plans continue to evolve up to and even during an event. Moreover, it is rare for only one person to be involved in developing a plan. Coordinating events between two or more people is observed to be a highly iterative and disjointed process. This is especially true for information events which can start with a casual comment between two people and evolve into a planned event among many people. The constant conversation and coordination revolving around the event can cause it to gain momentum and become even more significant. There typically is no formal planning process for these types of casual events, and one is often not desired. Instead, what many users want is a cohesive history of the conversation building to the event that can span time, variable amounts of people, and multiple communication tools such as phone calls, text messaging, instant messaging, e-mail, and the like. The system 100 enables sharing of the polymorphic note among a group of users to record and leverage this type of group dynamic.

The time-critical factor among plans can vary widely and also affect the development of an idea or plan. For example, time spans associated with an idea or event can range from “I have a meeting in five minutes” to “I want to go to Australia this summer” to “I want to go skydiving someday.” In fact, some plans cannot or are not tied to a specific time. The flexible nature of the polymorphic note enables the note to capture any of these time frames within a common object construct.

In a sample use case, a user is in constant contact with her friends via a shared polymorphic note. The user and her friends are planning to attend meet up at one of the many parties to which they have been invited on a Saturday night. The user receives an update to the shared polymorphic note and sees that one of her friends is suggesting a particular party. The user and her friends vote on whether to attend the suggested party and arrange to meet at the party at a particular time based on the vote. Both the vote and the resulting scheduled meeting time is facilitated by and recorded in the polymorphic note. In one embodiment, the vote may include an indication of the time the user will join the resulting scheduled meeting. The users can come to the meeting/event at different times during the meeting/event; the arrival times can be noted or recorded in the polymorphic note. Moreover, the user can give a partial acceptance, e.g., arriving 10 pm or arriving 11 pm and departing 12 pm, etc. All of this information may be presented to users via the polymorphic note.

As shown in FIG. 1, the system 100 comprises user equipment (UEs) 101a-101n having connectivity to a polymorphic note manager 103 and a service platform 105 via a communication network 107. In one embodiment, the polymorphic note manager 103 facilitates the generation of a polymorphic note to record user events or other similar PIM related information over, for example, a period of time. The polymorphic note manager 103 also facilitates the subsequent access and/or manipulation of the polymorphic note by a polymorphic note application (e.g., polymorphic note applications 109a-109n) executed by the UEs 101a-101n or by one or more of the services 111a-111n of the service platform 105. In one embodiment, the services 111a-111b include a suite of services such as a location management service (e.g., a mapping service or navigation service), contact management service, messaging service, social networking service, media content service (e.g., music service, video service, etc.). In another embodiment, the polymorphic may contain triggering information (e.g., time, people, place, etc.) to initiate corresponding actions or functions provided by the polymorphic note manager 103, the services 111a-111n, and/or any other services available over the communication network 107. In addition or alternatively, the polymorphic note manager 103 may operate a web server to facilitate access to and/or manipulation of the polymorphic note using a web browser (not shown) executed on one or more of the UEs 101a-101n. In this way, the UEs 101a-101n need not execute a polymorphic note application 109 to access the functions of the polymorphic note manager 103.

In one embodiment, the polymorphic note manager 103 generates a polymorphic note that includes information of a plurality of application types in which the information is developed or evolved over period of time. The polymorphic note manager 103 stores the information in, for instance, the database 113 of user note data. In addition or alternatively, the user note database 113 can reside on one or more nodes connected directly or indirectly to one or more of the services 111a-111n. In other embodiments, the user note database 113 resides one or more nodes in the network 107. More specifically, the user note database 113 includes one or more processes (not shown) and one or more data structures that store polymorphic notes and related information as well as data, configurations, user profiles, variables, conditions, and the like associated with operation of the polymorphic note manager 103 and/or the polymorphic note applications 109a-109n. The polymorphic note manager 103 may also organize any generated polymorphic notes into one or more electronic notebooks. These notebooks can then be shared among one or more other users so that the other users can collaborate in developing the polymorphic note as described previously. By way of example, the notebooks may be assigned attributes (e.g., work, home, personal, private, etc.) that direct how and to whom the notebook is shared.

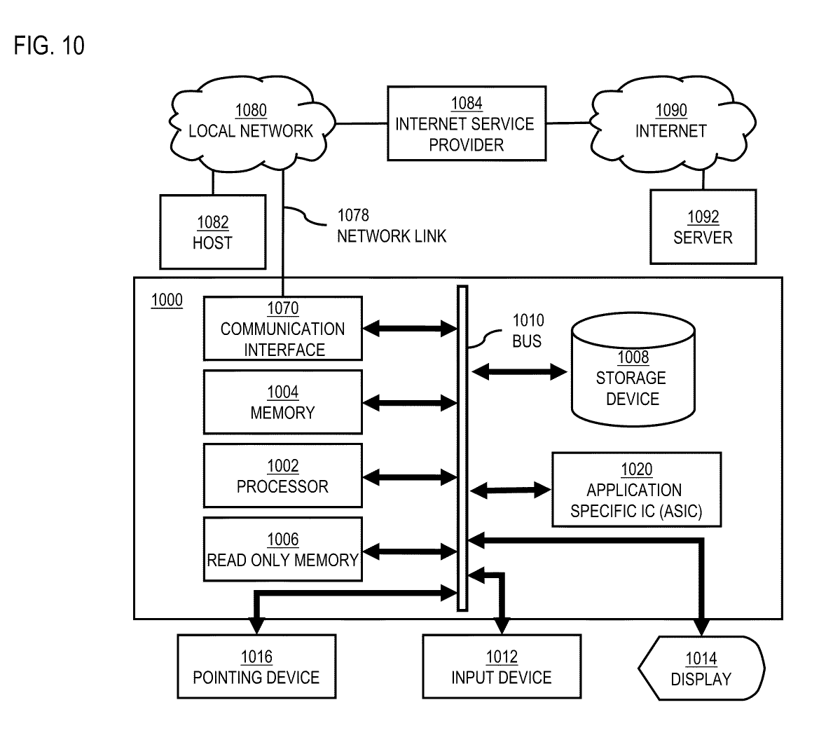

In one embodiment, the polymorphic note manager 103 and the service platform 105 can be implemented via shared, partially shared, or different computer hardware (e.g., the hardware described with respect to FIG. 10).

By way of example, the communication network 107 of the system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UEs 101 are any type of mobile terminal, fixed terminal, or portable terminal including a mobile handset, station, unit, device, multimedia tablet, multimedia computer, Internet node, communicator, desktop computer, laptop computer, Personal Digital Assistants (PDAs), or any combination thereof. It is also contemplated that the UE 101 can support any type of interface to the user (such as “wearable” circuitry, etc.). The UE 101 may also be equipped with one or more sensors (e.g., a global positioning satellite (GPS) sensor, accelerometer, light sensor, etc.) for use with the services 111a-111n.

By way of example, the UEs 101, the polymorphic note manager 103, and the service platform 105 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the polymorphic note application 109a and the polymorphic note manager 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. In one embodiment, the server is integrated as part of the client.

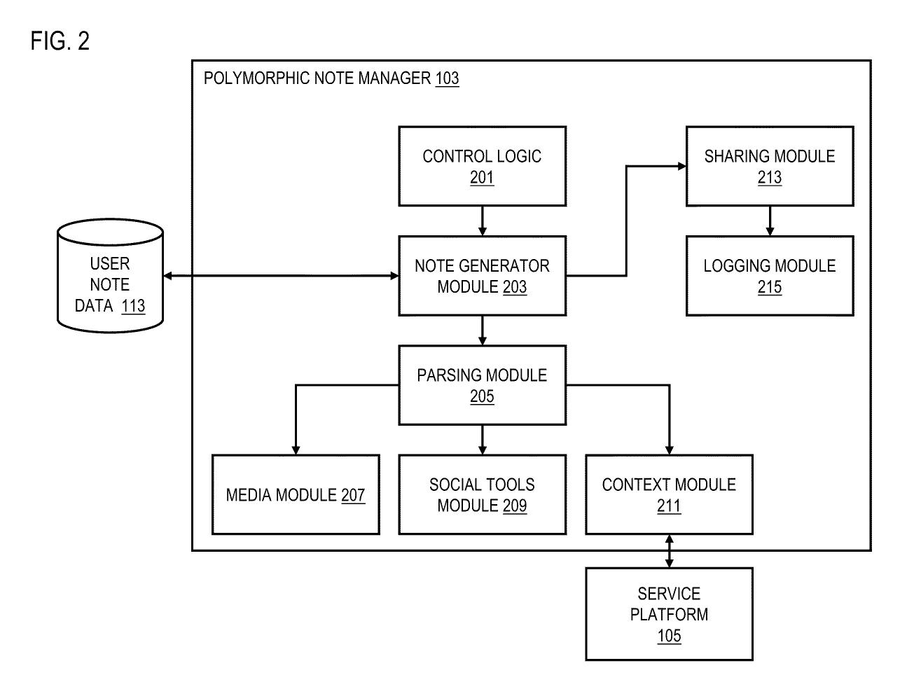

FIG. 2 is a diagram of components of polymorphic note manager, according to one embodiment. By way of example, the polymorphic note manager 103 includes one or more components for generating, sharing, and updating a polymorphic note. It is contemplated that the functions of these components may be combined in one or more components or performed by other components of equivalent functionality. In this embodiment, the polymorphic note manager 103 includes at least a control logic 201 which executes at least one algorithm for executing functions of the polymorphic note manager 103. For example, the control logic 201 interacts with the note generator module 203 to receive a request, from a user, to generate a polymorphic note. The request can be initiated via the polymorphic note application 109 or a via a web portal provided of the polymorphic note manager 103 by initiating a command to create a new polymorphic note. In one embodiment, the new polymorphic note may be created as a blank note or as a duplicate of an existing note that can then be edited.

It is contemplated that the request can include any amount or specificity of information to initiate the creation of a polymorphic note. In the example of FIG. 2, the note generator module 203 interacts with the parsing module 205 to analyze any textual input that may have been provided in the request to determine at least a part of the information to include in the polymorphic note. More specifically, the parsing module 205 enables input of information using free-form text input. For instance, a user can simply type “Meet with Steve at 6 pm next Thursday at Molly McGees,” resulting in the parsing module 205 creating a meeting at 6 pm next Thursday with the location “Molly McGees.” The parsed results can then be presented to the user for confirmation and/or correction. In addition or alternatively, the note generator module 203 can present the user with a traditional input selection form to provide information for inclusion in the polymorphic note. The note generator module 203 may also determine whether any common attribute or information (e.g., event time, location, etc.) is missing from the information provided in the initial request and prompt or provide a reminder to the user that the information is missing (e.g., “Please set a start time for your event”). In one embodiment, the request to create the polymorphic note can be indicated by non-textual means. For example, the user can initiate a request by pointing out a location (e.g., a point of interest (POI)) on a digital map. The specified map location will then mean, for instance, the location of the event described in the polymorphic note.

Next, either the note generator module 203 or the parsing module 205 can interact with the media module 207, social tools module 209, and/or context module 211 to supplement the information included in the polymorphic note. The media module 207, for instance, enables the insertion or attachment or linking of media (e.g., audio, video, etc.) and/or document files to the polymorphic note. Once the media content is inserted into the polymorphic note, the media content effectively becomes a part of the polymorphic note and is transported (e.g., transmitted or copied to another UE 101 or node of the network 107) as a unit with the polymorphic note until the media is otherwise removed.

In embodiment, the social tools module 209 enables the addition any number of social tools to any polymorphic note. Examples of social tools are a blog-like conversation thread, multiple choice voting, shared tasks, commenting, etc. For example, each of the social tools enables multiple users to interact with or express comments about the information in the polymorphic note. These interactions and/or comments can be recorded in the polymorphic note. In one embodiment, the social tools and information included in a polymorphic note may be different or presented differently depending on the intended recipients of the note, e.g., family members may not need as much information as business associates or vice versa when they are invited to the same party. Accordingly, the user, when requesting generation of the polymorphic note, can specify what information is displayed depending on the intended recipients.

The context module 211 enables the polymorphic note manager 103 to automatically determine attributes (e.g., location, people, time, etc.) of the polymorphic note that can be retrieved from either one or more of the services 111 of the service platform 105 and/or a sensor included in the UE 101 associated with the user. By way of example, place attributes can be set via navigation of places specified in the user's contact list or through a maps database or determined by a location-based sensor (e.g., GPS satellite receiver). In this case, the user can select or enter a location for recognition by the context module 211. It is contemplated that the polymorphic note may be associated with any number of locations.

Similarly, people attributes can be set through selection from the user's contact list or a public directory. In another embodiment, the user may begin typing the names of people to associate with the polymorphic note. The context module 211 can then match the typed name against the user's contact list or public directory to specify the name. It is contemplated that the user can associate any number of names with the polymorphic note. The time attributes can be set via traditional calendar views or a clock of the UE 101.

After generating the polymorphic note, the polymorphic note manager 103 interacts with the sharing module 213 to share the polymorphic note with other users. In the approach described herein, individual polymorphic notes as well as notes aggregated in electronic notebooks may be shared. Sharing can be “read only” (e.g., other users can view but not edit the data) or “read/write” (e.g., other users can edit any attribute or information in the polymorphic note). In one embodiment, the owner or creator of the note can share a note. If the note creator shares a note and then deletes it (or unshares it), the recipients receive, for instance, notification of the deletion or unsharing. In certain embodiments, the sharing module 213 will ask whether the recipient would like to make a local copy of the shared polymorphic note, which creates a static snapshot of the note for the recipient. This local copy is no longer linked to the original polymorphic note. The copying is offered because having a creator delete a note might be unnerving to the recipient if the recipient added information to the note, wanted to keep a record of the note contents, etc. If a recipient is removed from sharing a note, creates the recipient's own copy, and is later added back to the sharing the same polymorphic note, the sharing module 213 can offer to merge the local copy into the original note. In one embodiment, a note or notification of a note that is no longer more valid may disappear from the recipient's notes display (e.g., on a the recipient's device) after a predetermined validity time has expired. The expiration may be determined, for instance, by comparing the time of validity to the clock of the user's device. It is noted that the note is only removed from the display note from memory; the note can still be accessed or linked to other notes if needed based on the dependencies between the notes.

In addition, UEs 101 associated with the users of the polymorphic note can be temporarily disconnected from the network 107, therefore, local copies of the polymorphic note are often edited and synchronization conflicts can arise. In embodiment, the sharing module 213 handles the synchronization and synchronization conflicts. If a user encounters synchronization conflicts with the user's own notes (e.g., when editing a polymorphic note through both the web portal and a disconnected mobile device such as a handheld mobile computer and then reconnecting the mobile device), the user is prompted directly as to how to resolve the conflict or discrepancy (e.g., asked which version to accept).

However, in the social setting of shared polymorphic notes, conflicts can be resolved differently. Upon information conflicts or discrepancies caused by different users, the users causing the conflict are presented with options to (socially and gracefully) resolve the conflict, including contacting each other directly (with contact information), adding to the polymorphic note's conversation thread, and/or making a personal copy of the polymorphic note to save changes.

As shown, the sharing module 213 has connectivity to the logging module 215. The logging module 215 operations to record updates to the polymorphic note by the owner or other users of the polymorphic note. In one embodiment, the logging module 215 also records information related to use of any of the social tools included in the polymorphic note. For example, this information includes results of voting, comments, status of shared tasks, etc.

Alternatively, users may access the functions of the polymorphic note manager 103 via an access control application (e.g., the polymorphic note application 109) in the UE 101 such as a widget, according to another embodiment. Widgets are light-weight applications, and provide a convenient means for presenting information and accessing services. It is contemplated that the functions of these components may be combined in one or more components or performed by other components of equivalent functionality. In this embodiment, the polymorphic note application 109 includes modules similar to those of the polymorphic note manager 103, as previously described. To avoid data transmission costs as well as save time and battery, its control logic can fetch polymorphic note data cached or stored in its own database, without requesting data from any servers or external platforms, such as the polymorphic note manager 103 or the service platform 105.

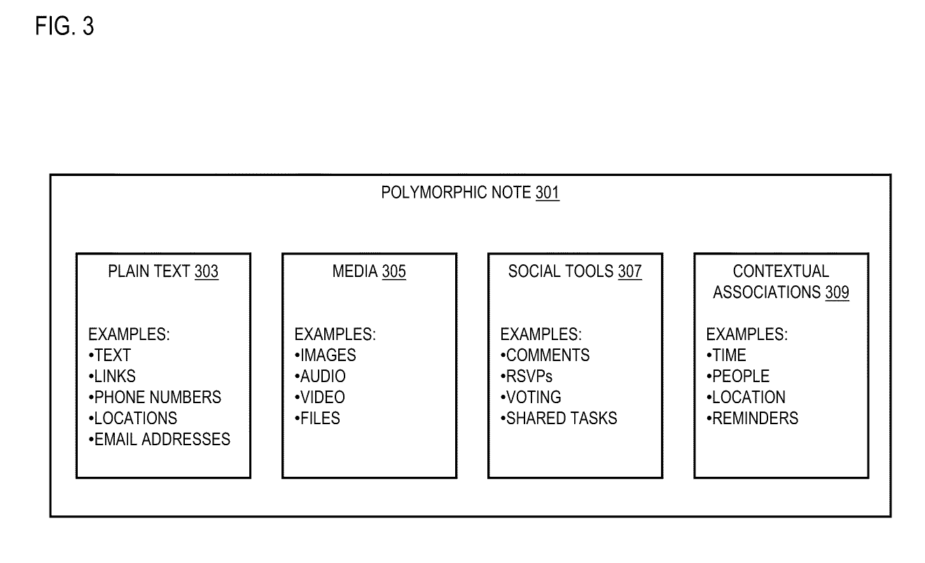

FIG. 3 is a diagram of components of a polymorphic note, according to one embodiment. As shown in FIG. 3, a polymorphic note 301 includes four main sections: (1) a plain text section 303, (2) a media content section 305, (3) a social tools section 307, and (4) a contextual associations section 309. The plain text section 303 includes text input specified by users of the polymorphic note. As described previously, the text input is parsed to identify information such as web links, phone numbers, locations, e-mail addresses, and the like. The parsed information can then be used to determine one or more attributes (e.g., data elements) of the polymorphic note.

The social tools section 307 provides features to make polymorphic notes a social experience. For example, the social tools section 307 provides for a range of social interactions including commenting functions whereby users of the polymorphic note can provide commentary on any topic supported by the polymorphic note. The commentary can then be viewed by other users and included as part of the logged history of the polymorphic note for later access. The section 307 also provides for a structured task list for assigning tasks to one or more users of the polymorphic note. The polymorphic note can then document the assignments and completion status of the tasks. An example of another social tool is a voting or polling function which enables multiple people to set up a vote of any topic of interest (e.g., where to go for lunch, meeting dates and times, favorite actor, etc.). Yet another social function is the RSVP list which shows response of users who have been invited to a particular event.

The contextual associations section 309 enables the polymorphic note manager 103 to associate information such as time, people, location, reminders, and status with the polymorphic note. For example, with respect to time, the polymorphic note manager by default associates the creation time with polymorphic note. If a user of the polymorphic note sets a specific time (e.g., a start time, duration, end time, etc.), the set time replaces the default creation time. As described earlier, people and location can be obtained from sensors of the UE 101 or from one or more services 111 related to the contextual association. In one embodiment, the notes may be linked with each other so that the notes form a journey or chain. In one embodiment, the polymorphic note manager 103 will suggest a link between two or more notes depending on, e.g., the relevancy or similarities of the notes.

With respect to reminders, user can associate one or multiple reminders to a note. These reminders can then appear online via the web portal or on the UE 101 of the user via the polymorphic note application 109. By way of example, the type of reminder that is presented depends on the type of associations the user has added to the note.

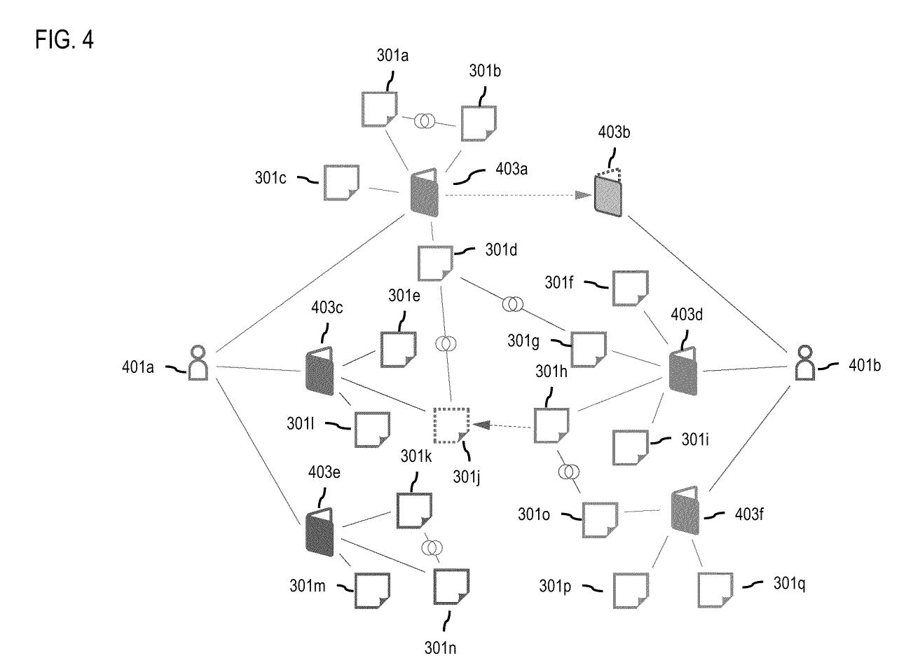

In one embodiment, polymorphic notes have both “private” attributes that only the note creator or owner can view and edit, as well as “public” attributes that are viewable and sometimes editable by others through note sharing. By way of example, private attributes include the name of the notebook in which the polymorphic note is stored (e.g., see discussion of notebooks with respect to FIG. 4 below), personal flags, soft and hard reminders. Public attributes include the note title, the note body (which can contain text, clickable URLs, pictures, video clips, audio clips, and links to other notes), a variety of social tools (including voting for several options, RSVP, checklists, conversation thread, etc.), and a revision history (which anyone can view, but only the note creator can “undo” to a certain point in the history).

In another embodiment, polymorphic notes can be formatted and/or skinned. The note body allows, for instance, font color/family/size and similar common text formatting, background color and/or image, similar visual formatting. By way of example, an image of the location or POI associated with a polymorphic note can be used as a background for the note. This image may be obtained from, for instance, a mapping service of the service platform 105 or from a picture collection of the creator of the note. In yet another embodiment, the picture or formatting theme of the note may be selected to reflect advertising, marketing, branding, or other similar purposes. Users can create a blank note, apply formatting, and then save the note as a new formatting note “template,” for easy application to other notes in the future.

FIG. 4 is a diagram illustrating organization of a plurality of polymorphic notes into electronic notebooks, according to one embodiment. As shown in FIG. 4, polymorphic notes may be grouped into notebooks, which, in one embodiment, are the primary organizational tool available to users. Notebooks service three primary functions: (1) separations of polymorphic notes for sharing (or isolating), (2) managing subscriptions to indicate what polymorphic notes are shared with particular users, and (3) arbitrary organization of polymorphic notes.

In one embodiment, for each user, a polymorphic note exists in one notebook. Users may have multiple notebooks including predetermined default notebooks if needed. Notebooks also have certain attributes that can be easily changed such as the list of users sharing the polymorphic note can be easily changed or a default display theme. For example, a user 401a can have a notebook 403a for the user's work calendar, a notebook 403c for family organization, and a notebook 403e for the local sports calendar. This organization scheme enables the user to easily sort the user's notes and focus on the items of most interest or importance.

In addition, notes (e.g., notes 301a-301b) can be linked to each other to provide an explicit relationship between them and to facilitate easy navigation between them and/or indicating sequence of the notes. Linking (e.g., indicated by the lines with a double circle) is independent of the notebooks 403a-403f, and any two notes 301 may be linked, though only two notes 301 may be associated with any single link.

For example, if a user decides to create a note for a birthday party and invite friends to it, she can then create a related note 301 to remind her to bake a cake and to shop for ingredients of the cake on time, and another related note 301 to remind her to talk to a friend about buying a birthday present. This way she can easily hop between the related notes 301 while she is thinking about them without sending all of this information along with the invitation.

In one embodiment, both the notebooks 403 and the linking are personal and are not shared, with the exception of the shared notebook 403a/403b. In this case, all notes 301 within a shared notebook 403a are seen within the shared notebook 403a by all parties sharing the notebook 403a. In another embodiment, if a user has had individual notes 301 from a notebook shared with him, then the entire notebook 403 is shared. A prompt asks, for instance, if the user would like to move all existing notes from that notebook 403 into the now-shared notebook 403.

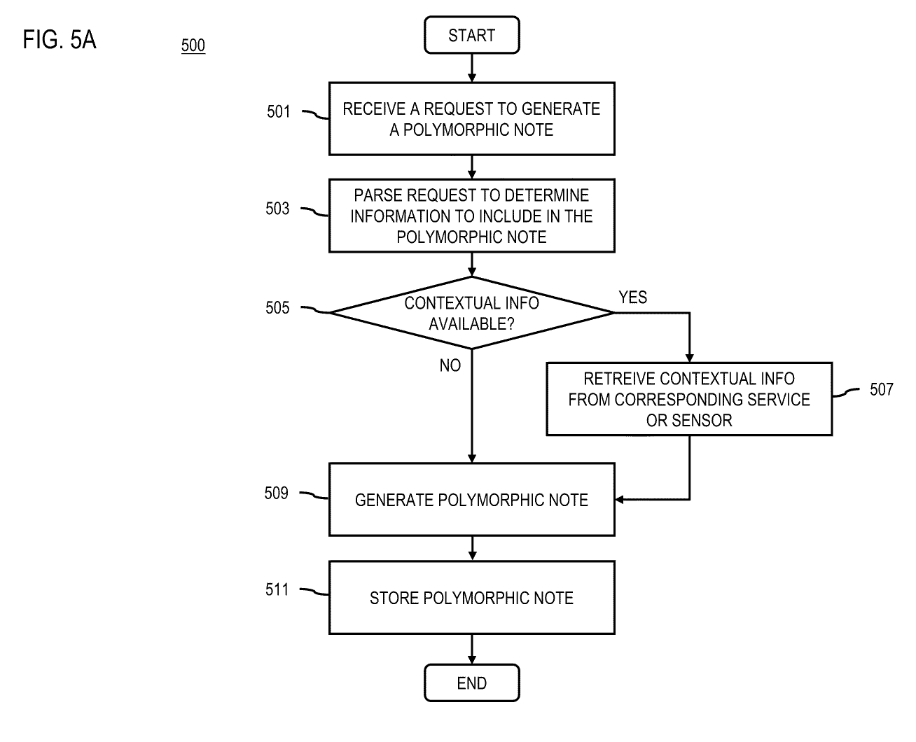

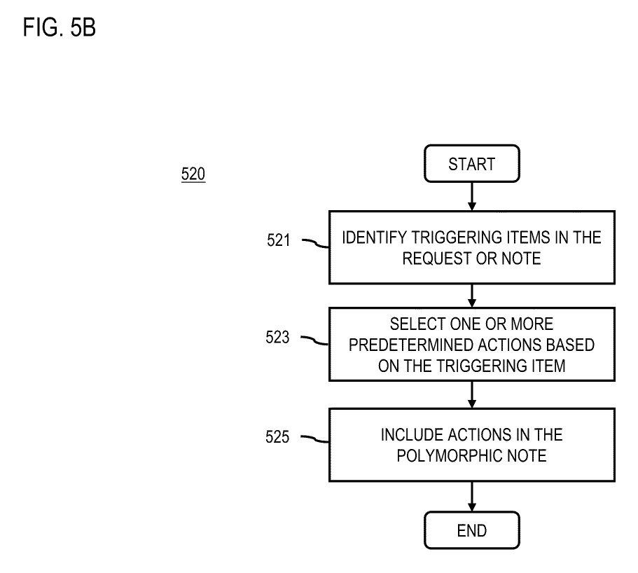

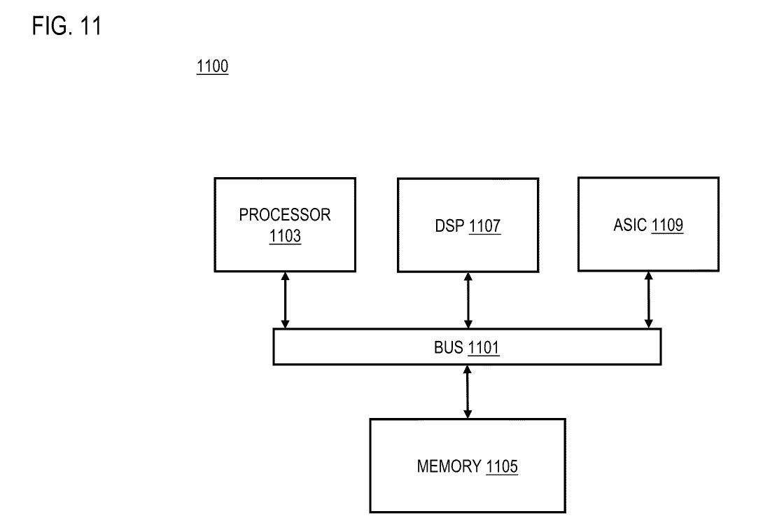

FIGS. 5A and 5B are flowcharts of a processes for generating a polymorphic note, according to various embodiments. FIG. 5A depicts a general process for generating the polymorphic note and FIG. 5B depicts an optional process for including predetermined actions in the polymorphic note. In one embodiment, the polymorphic note manager 103 performs the process 500 of FIG. 5A and the process 520 of FIG. 5B and is implemented in, for instance, a chip set including a processor and a memory as shown in FIG. 11. In step 501 of FIG. 5A, the polymorphic note manager 103 receives a request from a device to generate a polymorphic note. The device may be associated with a user, a service provider, content provider, network provider, or any other entity authorized or capable of initiating the request. As discussed previously, the polymorphic note may include information traditionally associated with a plurality of application types (e.g., a calendar application, a task management application, a note application, an e-mail application, an instant messaging application, a text messaging application, a social networking application, a location application, or a combination thereof). The support for multiple application types in the polymorphic note enables polymorphic note manager 103 to avoid imposing a strict data structure for input data. For example, to record an event in a traditional calendaring application, a user inputs a specific date, time, subject, etc. in the format required by the application. Instead, under the approach described herein, the user of the device can initiate the creation of a polymorphic note with just an idea or concept of an event (e.g., “I want to go hiking”), and the user need not know the specifics of the event (e.g., where, when, with whom, etc.). As the concept develops, the polymorphic note can record the evolution from concept to event.

The polymorphic note manager 103 then parses any input provided as part of the request to determine as much information as possible to include in the polymorphic note (step 503). For example, the parsing can be used to identify any phrases related to or specifying web links, phone numbers, locations, email addresses. The manager 103 can also parse the information to determine whether there are any referenced media content items or requested social tools (e.g., based phrases related to one or more of the social tools). The parsed information may also be used to identify any contextual information (e.g., time, place, location, etc.) or indicators of contextual information that can be retrieved from either one of the services 111 of the service platform 105 (e.g., a weather service to obtain a weather forecast for the place, date, and/or time described in the note) or from a sensor of the UE 101 associated with the device (steps 505 and 507). For example, the parsed information may include a phrase “dinner at Paul's house.” In this case, the polymorphic note manager 103 identifies the phrase as a possible invitation and that the location is Paul's house. Accordingly, the polymorphic note manager 103 searches the device's contact list (or other contact lists available via a contact service or another device) to identify Paul and retrieve a home address for Paul from the list or service. The manager 103 then obtains directions to Paul's home address from a mapping service of the service platform 105 and includes then address in the polymorphic note. The polymorphic note manager 103 can even determine a location based on the time. For example, the manager 103 can determine (1) whether Paul has a summer cottage, and (2) the periods of time (e.g., the summer) when Paul can be found at the cottage. The manager can then suggest the location (e.g., either Paul's home or Paul's summer cottage) based on the time of year. Similarly, the manager 103 can determine a location based on a daily work schedule or routine (e.g., work location during the day and home location at night).

After obtaining available information (e.g., contextual associations, media content references, social tools, etc.) identified by the parsing, the polymorphic note manager 103 generates the polymorphic note (step 509) and stores the note for later access or sharing by the device (step 511).

FIG. 5B depicts an optional process for including predetermined actions in the polymorphic note based on triggering items include in the note or the request to generate the polymorphic note. In step 521, the polymorphic note manager 103 parses the polymorphic note or the information received in the request to identify any triggering items. In one embodiment, a triggering item is information that is associated with an action or function of the polymorphic note manager 103, the services 111, the service platform 105, or any similar component available over the communication network 107. This information is, for instance, related to time, people, location, tasks, and other PIM information.

On identifying one or more triggering items, the polymorphic note manager 103 selects one or more predetermined actions that correspond to the identified triggering items (step 523). For example, the triggering item is information specifying the user's friend Matt, along with a restaurant, and meeting time, the polymorphic note manager 103 may select one or more actions to display the location of the restaurant on a map, create an online reservation at the determined time, etc. The polymorphic note manager 103 then includes the selected actions in the polymorphic note. For example, the note may contain scripts or other commands to direct the performance of the actions (step 525).

In one embodiment, the polymorphic note manager 103 can operate in conjunction with or be embedded in an external application (e.g., a word processor) to monitor for triggering items that can be used to generate polymorphic notes. For example, as a user types information in the word processor application, the polymorphic note manager 103 parses the typed information to identify triggering items according to the process 520. If the triggering items are detected, then polymorphic note manager 103 identifies the corresponding actions using the process 520 and then generates the polymorphic note to include the actions as described with respect to the process 500.

In one sample use case, one or more users may happen to be shopping in the same area of a city and have their location services configured to automatically share their locations. In this example, the triggering item includes information on at least location and people. Accordingly, the polymorphic note manager 103 may interface with the location service to initiate a suggestion as a polymorphic note to the users that they can easily meet up a nearby location (e.g., a coffee shop on Main Street). In some embodiments, the polymorphic note manager 103 may consult other polymorphic notes or PIM information (e.g., calendar and schedules) to automatically determine whether a meetup is possible and incorporate the scheduling information in the note. The note can also include, for instance, a voting social tool that asks the users to vote the place and time for meeting that the users can quickly respond. If the users accept the suggestion, the polymorphic note manager 103 automatically records the information related to the selected meetup (e.g., location, people, time, etc.) in the note. T

It is also contemplated that the polymorphic note manager 103 may convert an application type associated with another application into a polymorphic note. In this way, for instance, the external application file type may be used to suggest or create information that will be converted into a polymorphic at a later date.

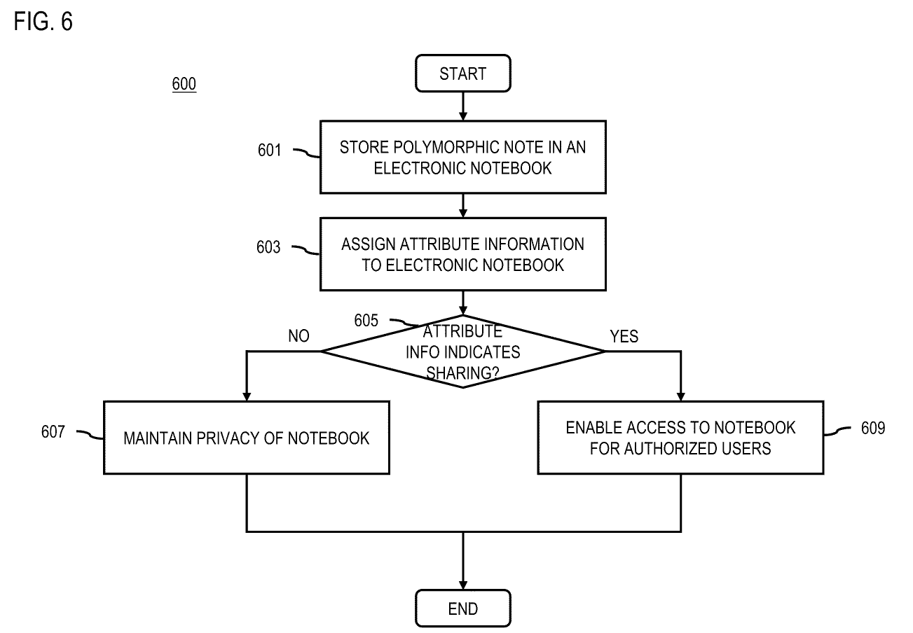

FIG. 6 is a flowchart of a process for storing and sharing a polymorphic note in an electronic notebook, according to one embodiment. In one embodiment, the polymorphic note manager 103 performs the process 600 and is implemented in, for instance, a chip set including a processor and a memory as shown in FIG. 11. In step 601, the polymorphic note manager 103 stores previously generated polymorphic notes in one or more electronic notebooks. As discussed earlier, electronic notebooks provide a convenient way to shares notes by enabling the device to manipulate collections (e.g., notebooks) of notes rather than each individual note. As part of the sharing process, the polymorphic note manager 103 assigns an attribute to the electronic notebook (step 603). This attribute, for instance, specifies the category of the notebook and the polymorphic notes contained therein (e.g., work, home, personal, sports, etc.). Each attribute may also be associated with a list of users who will receive and share the notebook. For example, a notebook with the work attribute can provide for sharing of the notebook among a group of the user's coworkers. A notebook marked home can provide sharing among the user's immediate family. In addition, the level of access may vary by group. For example, the work notebook may specify sharing as read-only; while the home notebook may specify sharing with full read/write access.

It is also contemplated that a notebook may not enable sharing altogether. For example, a notebook with the attribute of personal may be designated as private and not allow sharing. Accordingly, at step 605, the polymorphic note manager 103 determines whether the notebook's attribute indicates that the notebook should be shared. If the attribute indicates no sharing, the polymorphic note manager 103 maintains the privacy of the notebook and prevents the sharing of the notebook (step 607). In certain embodiments, the identification of the notebook is also protected such that an unauthorized user is not able to view even the title of a protected notebook. If the attribute indicates that sharing is allowed, the polymorphic note manager 103 identifies the users indicated by the attributed as authorized to access the notebook and enables access to the notebook for those authorized users (step 609). It is contemplated that the polymorphic note manager 103 may use any mechanism (e.g., user name/password, network address filtering, biometric security, etc.) to authenticate the users to ensure that only authorized can access the notebook.

In another embodiment, the polymorphic note manager 103 may share individual polymorphic notes without first storing the note in an electronic notebook. In this case, the manager 103 applies the sharing attribute to the specific polymorphic note rather than the electronic notebook.

In another embodiment, the polymorphic note may be shared between devices of differing capabilities (e.g., between a desktop computer and a mobile device). In this case, the polymorphic note manager 103 may share or synchronize only those parts of the polymorphic note that is appropriate to the device. For example, due to limited device memory in a mobile device, the desktop computer may share only a subset of the media content included in a polymorphic note. In some embodiments, the desktop computer may then share the remaining media content as, for instance, a link. In addition, if the one of the devices is note compatible with the polymorphic note service (e.g., connect access polymorphic note file types), the polymorphic note may provide a summary of the polymorphic in a file format (e.g., e-mail, text message, etc.) that is compatible with the device.

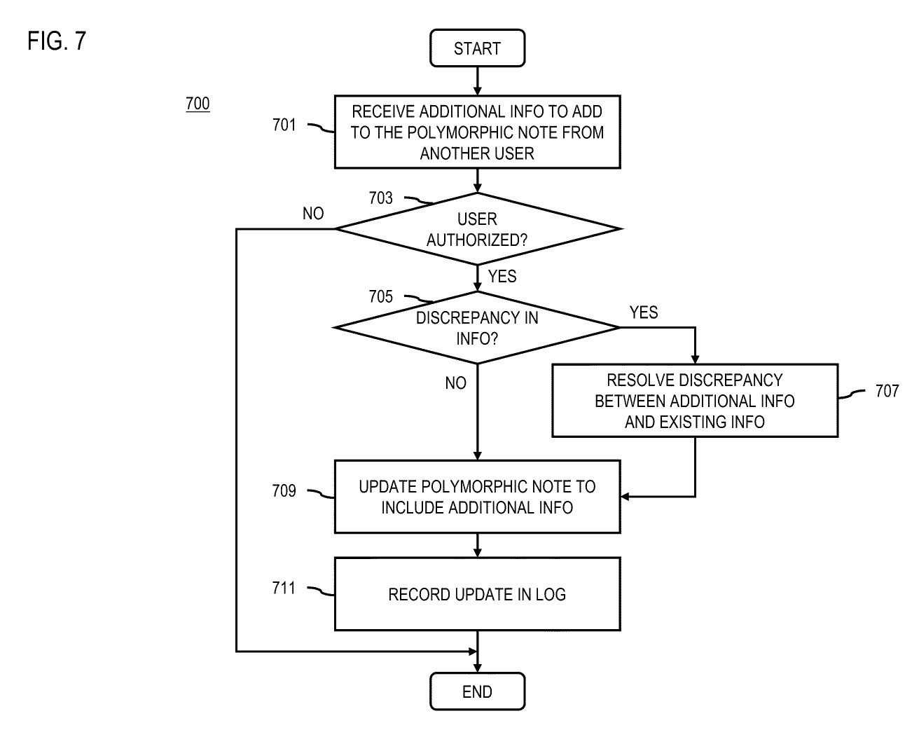

FIG. 7 is flowchart of a process for recording updates to the polymorphic note, according to one embodiment. In one embodiment, the polymorphic note manager 103 performs the process 700 and is implemented in, for instance, a chip set including a processor and a memory as shown in FIG. 11. The process 700 assumes that a polymorphic note created by a first device has been shared successfully shared with at least another device. In step 701, the polymorphic note manager 103 receives additional information to add to the shared polymorphic note from the other device. By way of example, this additional information may include any information element related to either polymorphic note or a communication (e.g., e-mail, text message, instant message, etc.) about the polymorphic note. The information may also include responses or inputs to any the social tools included in the polymorphic note.

On receipt of the information, the polymorphic note manager 103 determines whether the device is authorized to make the changes (e.g., have read/write access as opposed to read-only access) (step 703). If the device is not authorized the process ends. Otherwise, the polymorphic note manager 103 determines whether the additional information provided by the other device conflicts with any information currently in the polymorphic note (step 705). If a conflict is detected (e.g., the same information has been changed by multiple devices), the polymorphic note manager 103 initiates a process to resolve the discrepancy (step 707). As discussed earlier, in a social setting, the polymorphic note manager 103 attempts to resolve the conflict through negotiations between the users of the devices causing the conflict or discrepancy. More specifically, the polymorphic note manager 103 retrieves contact information from, for instance, a contact list of either one or the devices or a public directory and initiate a communication session between the two parties to resolve the conflict. If the conflict cannot be resolved through negotiation, then the polymorphic note manager 103 can apply a predetermined conflict resolution rule (e.g., accept the latest update, accept the first update, etc.).

After resolving any discrepancy or if there were not discrepancies, the polymorphic note manager 103 updates the polymorphic note to include the additional information (step 709) and records the update in a log maintained with the polymorphic note (step 711). The log, for instance, provides a history of updates and changes to the polymorphic note. In addition or alternatively, a history of updates and changes to the polymorphic note may be stored in the body of the note itself instead of the log. In another embodiment, the log is stored in the body of the polymorphic note.

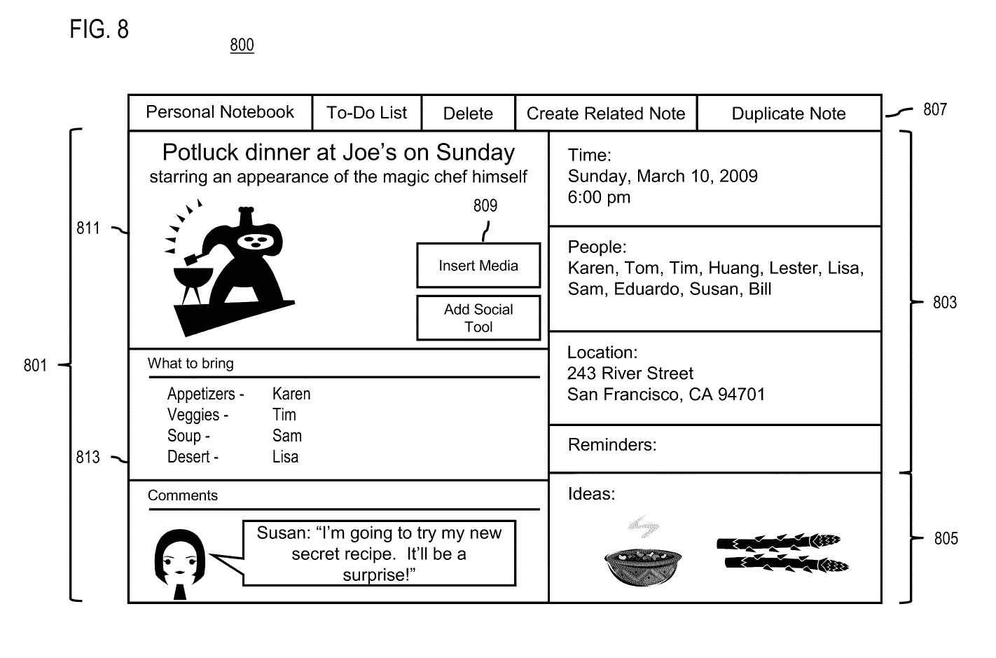

FIG. 8 is a diagram of a user interface for interacting with a polymorphic note, according to one embodiment. As shown, the user interface 800 depicts an example polymorphic note including a content region 801, association modules 803, ideas region 805, and settings and actions toolbar 807. The content region 801 is an area where users input content and includes text, media, and social tools that have been included in the polymorphic note. The association modules 803 display and enable users to input contextual associations such as time, people, location, and reminders to a polymorphic note. The ideas region 805 displays suggestions for ideas based on the content of the polymorphic note. The settings and actions toolbar 807 contain features that apply to the note as a whole, i.e., to the polymorphic note container and everything that belongs with it.

The content region 801 further includes three components: (1) the content tool bar 809, (2) the text and media region 811, (3) and the coordination tools region 813. The content tool bar 809 provides touchpoints for inserting different media types, adding coordination tools (e.g., task list, comments), and applying standard or customized themes to a note. The text and media region 811 is the main component of the polymorphic note user interface. For example, the text and media region 811 can contain any combination of text, images, video, audio, and other documents. It is designed to provide maximum flexibility across the range from simple text-only notes to carefully crafted invitations and memories with multimedia elements. The coordination tools region 813 supports the ability to share comments and carry on a conversation around a particular note. The region 813 also supports the ability to share and/or assign tasks related to the note, and the ability to vote on different options when trying to coordinate a group of people.

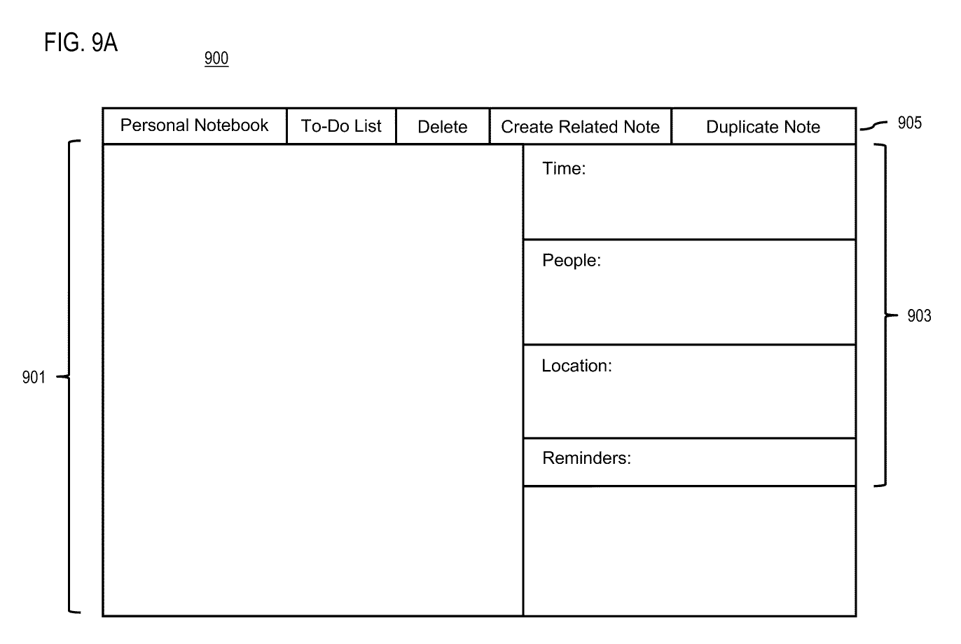

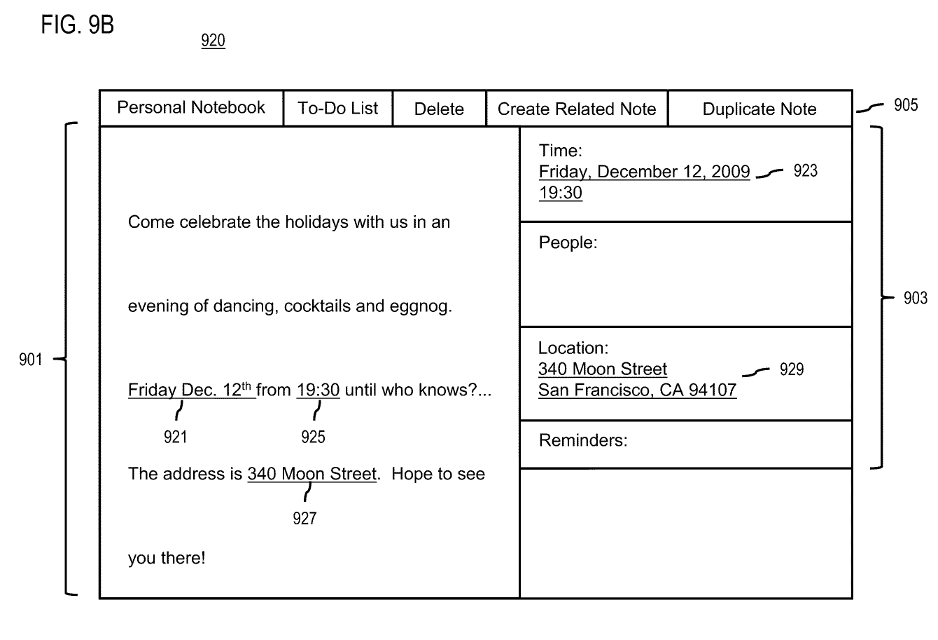

FIGS. 9A and 9B are diagrams of user interfaces for entering information into a polymorphic note, according to various exemplary embodiments. FIG. 9A depicts a user interface 900 of blank input screen for creating a polymorphic note. The user interface 900 is similar to the user interface 800 of FIG. 8 described above and includes a content region 901, association modules 903, and settings and actions toolbar 905. To request creation of a polymorphic note, the user begins typing information in the content region 901.

FIG. 9B depicts a user interface 920 in which the user has started to type information in the content region 901. As the user types, the polymorphic note manager 103 parses the information to determine contextual associations. The underlined phrase 921 (“Friday Dec. 12^{th}”) is parsed to indicate the date for a planned event. Although, the user has not input a year, the polymorphic note manager 103 can infer the complete date based on analyzing when December 12^{th} falls on a Friday and/or by assuming that the user is likely referring to the current year. Accordingly, the polymorphic note manager 103 displays the date in the time context 923 within the association modules region 903. Similarly, the underlined phrase 925 (“19:30”) is parsed to indicate the time for the planned event. The polymorphic note manager 103 includes this time in the time context 923 along with the date.

The underlined phrase 927 (“340 Moon Street”) is parsed to indicate an address of the planned event. The parsed address is incomplete. As a result, the polymorphic note manager 103 can use a mapping service, a location sensor in the user's device, and/or calendars or contacts of users related to the note to determine the city information. In another embodiment, the polymorphic note manager 103 may infer the city information to complete the address from, for instance, account information associated with the user. In this case, polymorphic note manager 103 determines the complete address and displays this address in the location context area 929 within the association modules region 903.

In the examples of FIGS. 9A and 9B, the user may confirm the accuracy of the parsed information and make modifications accordingly.

The processes described herein for generating a polymorphic note may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to generating a polymorphic note as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of generating a polymorphic note.

A bus 1010 includes one or more parallel conductors of information so that information is transferred quickly among devices coupled to the bus 1010. One or more processors 1002 for processing information are coupled with the bus 1010.

A processor 1002 performs a set of operations on information as specified by computer program code related to generate a polymorphic note. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or other dynamic storage device, stores information including processor instructions for generating a polymorphic note. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for generating a polymorphic note, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT) or a liquid crystal display (LCD), or plasma screen or printer for presenting text or images, and a pointing device 1016, such as a mouse or a trackball or cursor direction keys, or motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 107 for generating a polymorphic note.

The term computer-readable medium is used herein to refer to any medium that participates in providing information to processor 1002, including instructions for execution. Such a medium may take many forms, including, but not limited to, non-volatile media, volatile media and transmission media. Non-volatile media include, for example, optical or magnetic disks, such as storage device 1008. Volatile media include, for example, dynamic memory 1004. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set 1100 upon which an embodiment of the invention may be implemented. Chip set 1100 is programmed to generate a polymorphic note as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of generating a polymorphic note.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to generate a polymorphic note. The memory 1105 also stores the data associated with or generated by the execution of the inventive steps.

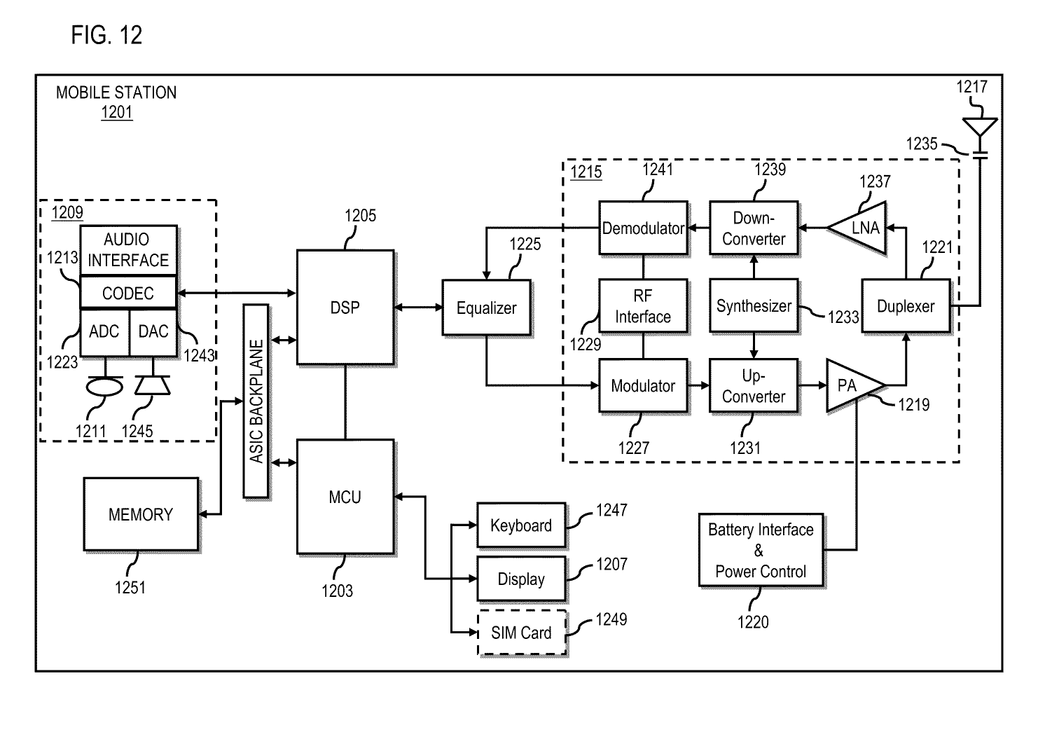

FIG. 12 is a diagram of exemplary components of a mobile terminal (e.g., handset) for communications, which is capable of operating in the system of FIG. 1, according to one embodiment. In some embodiments, mobile terminal 1200, or a portion thereof, constitutes a means for performing one or more steps of generating a polymorphic note. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of generating a polymorphic note. The display 12 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203—which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to generate a polymorphic note. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request, from a device, to generate a polymorphic note, wherein the polymorphic note includes information of a plurality of application types that is developed over a period of time;
generating the polymorphic note in response to the request; and
storing the polymorphic note for access by the device.

2. A method of claim 1, wherein the request is triggered by a triggering item in a media or a content, the method further comprising:
identifying the triggering item;
selecting one or more predetermined actions based on the identified triggering item; and
including the one or more predetermined actions in the polymorphic note.

3. A method of claim 2, wherein the triggering item includes information related to time, people, location, tasks, or a combination thereof.

4. A method of claim 1, wherein the plurality of application types includes a calendar application, a task management application, a note application, an e-mail application, an instant messaging application, a text messaging application, a social networking application, a location application, or a combination thereof.

5. A method of claim 1, further comprising:
storing the polymorphic note in an electronic notebook;
assigning attribute information to the electronic notebook; and
sharing the electronic notebook with the another device based on the attribute information,
wherein the sharing the notebook effects the sharing of the polymorphic note and any other polymorphic notes stored in the electronic notebook.

6. A method of claim 5, further comprising:
receiving an input, from the another device, for specifying additional information related to the polymorphic note or a communication concerning the polymorphic note;
resolving any discrepancies between the additional information and the information previously included in the polymorphic note;
updating the polymorphic note to include the additional information; and
recording the updating of the polymorphic note in a log associated with the polymorphic note.

7. A method of claim 1, wherein the polymorphic note includes plain text, media content, social tools, contextual associations, or a combination thereof, and the method further comprising:
parsing the request to determine at least a part of the information included in the polymorphic note.

8. A method of claim 7, wherein the social tools include conversation threading, voting, collaborative task lists, invitation management, commenting, or a combination thereof; the method further comprising:
recording use of one or more of the social tools in the log.

9. A method of claim 7, wherein the contextual associations include time, people, location, reminders, task status, or a combination thereof; the method further comprising:
determining the contextual information from related services, sensors of the device or the another device, or a combination thereof

10. An apparatus comprising:
at least one processor; and
at least one memory including computer program code,
the at least one memory and the computer program code configured to, with the at least one processor, cause the apparatus to perform at least the following,
receive a request, from a device, to generate a polymorphic note, wherein the polymorphic note includes information of a plurality of application types that is developed over a period of time,
generate the polymorphic note in response to the request, and
store the polymorphic note for access by the device.

11. A method of claim 10, wherein the request is triggered by a triggering item in a media or a content, the apparatus is further caused to:
identify the triggering item;
select one or more predetermined actions based on the identified triggering item; and
include the one or more predetermined actions in the polymorphic note.

12. A method of claim 11, wherein the triggering item includes information related to time, people, location, or a combination thereof.

13. An apparatus of claim 10, wherein the plurality of application types includes a calendar application, a task management application, a note application, an e-mail application, an instant messaging application, a text messaging application, a social networking application, a location application, or a combination thereof.

14. An apparatus of claim 10, wherein the apparatus is further caused to:
store the polymorphic note in an electronic notebook;
assign attribute information to the electronic notebook; and
share the electronic notebook with the another device based on the attribute information,
wherein the sharing the notebook effects the sharing of the polymorphic note and any other polymorphic notes stored in the electronic notebook.

15. An apparatus of claim 14, wherein the apparatus is further caused to:
receive an input, from the another device, for specifying additional information related to the polymorphic note or a communication concerning the polymorphic note;
resolve any discrepancies between the additional information and the information previously included in the polymorphic note;
update the polymorphic note to include the additional information; and
record the updating of the polymorphic note in a log associated with the polymorphic note.

16. An apparatus of claim 10, wherein the polymorphic note includes plain text, media content, social tools, contextual associations, or a combination thereof, and wherein the apparatus is further caused to:
parse the plain text to determine at least a part of the information included the polymorphic note.

17. An apparatus of claim 16, wherein the social tools include conversation threading, voting, collaborative task lists, invitation management, commenting, or a combination thereof; the apparatus is further caused to:
record use of one or more of the social tools in the log.

18. An apparatus of claim 16, wherein the contextual associations include time, people, location, reminders, task status, or a combination thereof, and the apparatus is further caused to:
determine the contextual information from related services, sensors of the device or the another device, or a combination thereof.

19. A computer-readable storage medium carrying one or more sequences of one or more instructions which, when executed by one or more processors, cause an apparatus to at least perform the following steps:
receiving a request, from a device, to generate a polymorphic note, wherein the polymorphic note includes information of a plurality of application types that is developed over a period of time;
generating the polymorphic note in response to the request; and
storing the polymorphic note for access by the device.

20. A computer-readable storage medium of claim 19, wherein the apparatus is further caused to perform:
storing the polymorphic note in an electronic notebook;
assigning attribute information to the electronic notebook; and
sharing the electronic notebook with the another device based on the attribute information,
wherein the sharing the notebook effects the sharing of the polymorphic note and any other polymorphic notes stored in the electronic notebook.
